(19) United States
(12) Patent Application Publication
(10) Pub. No.: US 2011/0061192 A1
(43) Pub. Date: Mar. 17, 2011

(54) Windshield wiper system for a vehicle cabin

(75) Inventor: Conrad Mueller, Zell Am Main (DE)

(73) Assignee: Noell Mobile Systems GmbH, Wuerzburg (DE)

(21) Appl. No.: 12/807,020

(22) Filed: Aug. 26, 2010

(30) Foreign Application Priority Data
Aug. 28, 2009 (DE) 20 2009 011 633.6

(51) Int. Cl. B60S 1/02

(52) U.S. Cl. 15/250.31

(57) ABSTRACT

A windshield wiper system for a vehicle cabin has two drive motors with glass wipers for cleaning a largely rectangular surface area. Two axes of the motors are disposed diagonally in the corner regions of the surface to be wiped. One wiper arm and wiper blades are disposed on these axes, the wiping movement of the wiper blades being guided from a position largely parallel from one side of the surface to be wiped to largely parallel to the other side of the surface to be wiped. The window panes of driver cabins with largely rectangular surface areas can be kept free of dirt at any time under difficult weather conditions over their entire viewing surface so that the operating personnel is given the possibility to view all the activities taking place about the cabin without having to adopt unfavourable positions with respect to their operating equipment.

### CROSS REFERENCE TO RELATED APPLICATIONS

Applicant claims priority under 35 U.S.C. §119 of German Application No. 20 2009 011 633.6 filed Aug. 28, 2009.

### BACKGROUND OF THE INVENTION

1. Field of the Invention

The invention relates to a windshield wiper system for a vehicle cabin with largely rectangular surface areas, in particular for a vehicle cabin in a straddle carrier. The invention is useful wherever rectangular surface areas of cabins, in particular of vehicle cabins, need to be cleaned as completely as possible, i.e., from one side of the rectangular window pane to the other side, so that the operating personnel or the driver of the vehicle is allowed to see perfectly into the spaces located underneath and above the cabin, even under difficult weather conditions.

2. The Prior Art

Vehicle cabins of straddle carriers are arranged so that the operating personnel or the driver is always capable of having a good and clear view of spaces located above or at the same height as the cabin, since containers are taken hold of, set down and must be displaced at high speed between container fork lifts. Places to set down containers in harbors generally have a dusty underground so that the cabin panes are covered with dirt. In addition, harbour facilities are often subject to unfavorable weather conditions with storm and rain. As a result, the window panes of the vehicle cabin often get dirty and must be cleaned while in operation. This is only possible with the help of windshield wiper systems since the cabins are often disposed at a considerable height above the ground, on the vehicle. Since driver must be able to see through the entire surface of the window pane for safety reasons, there is a demand for a windshield wiper system that cleans the window pane as completely as possible.

German Patent Application No. DE 3 415 614 C2 describes two wipers arranged parallel to each other which are connected together by a mechanism. European Patent No. EP 1 824 413 B1 describes a windshield wiper system for vehicles, in particular for automotive vehicles, wherein two wiper systems are joined together by a drive rod, and a single drive activates two wipers through a wiper rod.

European Patent Application No. EP 1 777 130 A1 describes a motor-driven, overlap windshield wiper system comprising two glass wipers. These are joined together by a connection rod and an intermediate lever so that the movement of rotation of a crank arm results in a reciprocating movement of the two wiper arms.

German Patent Application No. DE 10 2005 01 5038 A1 describes a glass wiper for panoramic windows of a vehicle. The glass wiper comprises at its mount a pivotal axis for the surface to be wiped from one side to the other. The wiper blade is pivotally carried largely parallel to the wiper's axis.

U.S. Pat. No. 3,044,095 describes a system in which two glass wipers are arranged on two opposing rotating axes that initiate a circular wiping movement of the wiper arms by means of a connection piece driving the two rotating axes.

The windshield wiper systems described above do not allow for cleaning a largely rectangular surface of a glass pane of a vehicle cabin in such a manner that the driver of the vehicle is capable of looking through a largely completely clean surface.

### SUMMARY OF THE INVENTION

Therefore, it is an object of the invention to develop a windshield wiper system for cleaning largely rectangular surface areas of a driver cabin.

This object is achieved according to the invention by a windshield wiper system which consists of two drive motors on which glass wipers are disposed for cleaning a largely rectangular surface area. The drive motors and with them the axis of rotation of the glass wipers are disposed diagonally in the region of the corners of the surfaces to be wiped, the glass wiper consisting of an arm and of a joint for the wiper blade. Advantageously, the axes of the drives for the wipers are disposed substantially diagonally opposite to each other, one underneath and one above the rectangular surface area to be wiped.

The wiping movement of the wiper blades is performed from a position largely parallel from the one side of the wiper surface to largely parallel to the other side of the wiper surface. The two wiper blades perform their wiping movement one after the other so that they do not hinder one another.

Since the vehicle driver of a straddle fork lift needs to have a good view on all sides at any time, it is advantageous to have the windshield wiper system disposed on every side of the cabin. Further, it is advantageous to dispose spray nozzles for a glass wash liquid at appropriate locations about the surface to be wiped. In principle, points located in the frame surrounding the surface to be wiped are appropriate locations. Due to the size of the surface, it is advantageous to dispose several spray nozzles. It has been found advantageous to dispose the spray nozzles above and/or underneath the surface to be wiped or to mount the spray nozzles directly on the axes for the wiper arms.

It is also advantageous to circulate the spray liquid with a hose or another suitable feeding device into the wiper arm or into the wiper blade, and to arrange at least one or several spray nozzles in the wiper arm or/and directly on the wiper blade. The spray nozzles may be arranged such that the spray jet is delivered in the wiping direction.

Insofar as the spray nozzles are disposed above and underneath the surface to be wiped, it has been found advantageous to dispose three spray nozzles on the surface area to be wiped. If the three spray nozzles are disposed in a side-by-side relationship, their spray angle is to be chosen such that the entire surface to be wiped is wetted by the spray jet.

Further, it is advantageous to synchronize the function of the spray nozzles with the position of the wiper blades in such a manner that a spray jet impacts the surface to be wiped at the very moment when the wiper blades are respectively in a position parallel to the side of the surface to be wiped.

### BRIEF DESCRIPTION OF THE DRAWINGS

Other objects and features of the present invention will become apparent from the following detailed description considered in connection with the accompanying drawings. It is to be understood; however, that the drawings are designed as an illustration only and not as a definition of the limits of the invention.

In the drawings, wherein similar reference characters denote similar elements throughout the several views:

FIG. 1 shows a windshield wiper system of the invention with spray nozzles in the upper frame part of the cabin;

FIG. 2 shows a windshield wiper system of the invention with spray nozzles on the axes of the wiper blades;

FIG. 3 shows a windshield wiper system of the invention with spray nozzles located above and underneath the surface to be wiped;

FIG. 4 shows a windshield wiper system of the invention with three spray nozzles located at a distance above and underneath the surface to be wiped;

FIG. 5 shows a windshield wiper system with spray nozzles on the wiper arm;

FIG. 6 shows a windshield wiper system with spray nozzles on the wiper blade; and

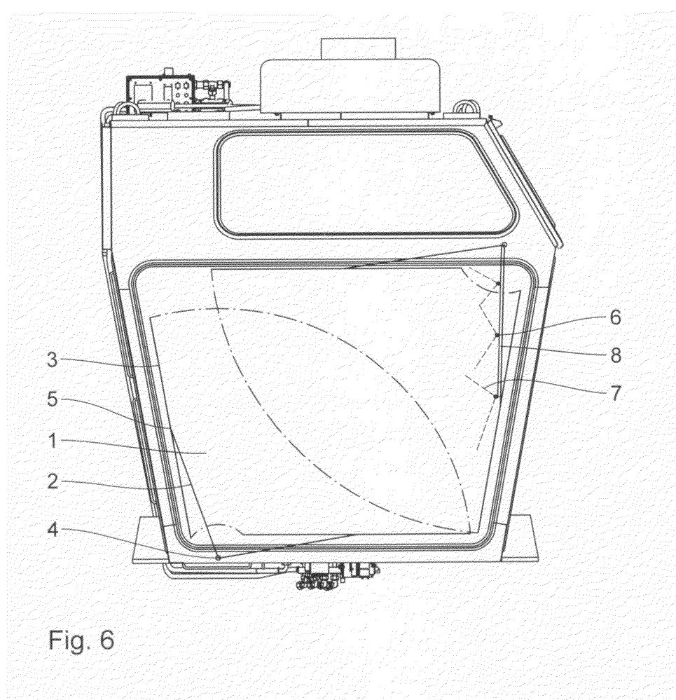

FIG. 7 shows a detail view of a wiper blade with a spray nozzle arranged thereon.

### DETAILED DESCRIPTION OF THE PREFERRED EMBODIMENT

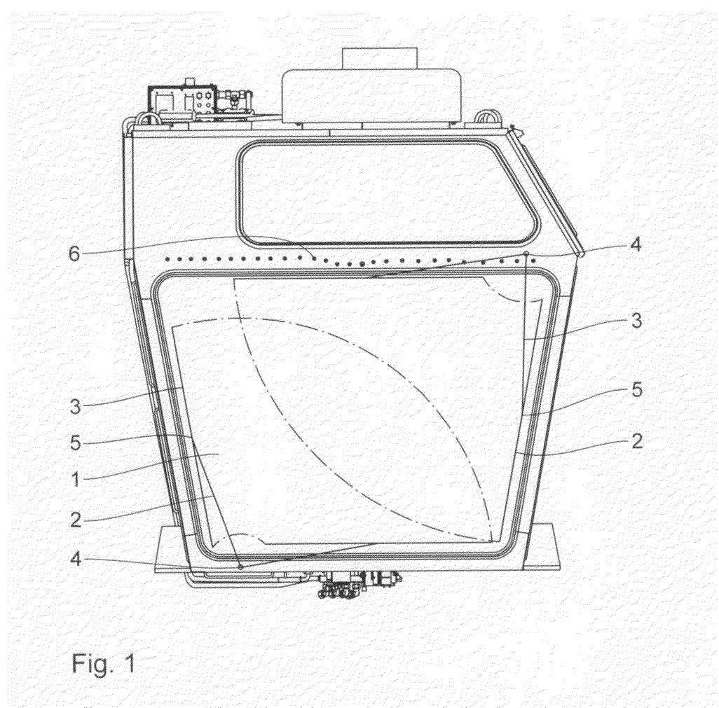

Referring now in detail to the drawings, FIG. 1 shows the driver cabin of a straddle carrier the window pane 1 of which comprises a largely rectangular surface area, the axes 4 of the drive motors being arranged diagonally opposite to each other and being located above or underneath the largely rectangular surface of window pane 1. Each wiper blade 3 is connected to the largely straight wiper arm 2 via a joint 5 and wipes parallely from one side of pane surface 1 to be wiped to the other side of pane surface 1 to be wiped, which adjoins the first side at right angles so that, through the overlap occasioned on the area to be wiped by both windshield wipers, the surface of the pane may be cleaned almost completely so that the vehicle driver has free viewing surfaces. For improved cleaning of the window pane 1, spray nozzles 6 are arranged above the surface to be cleaned.

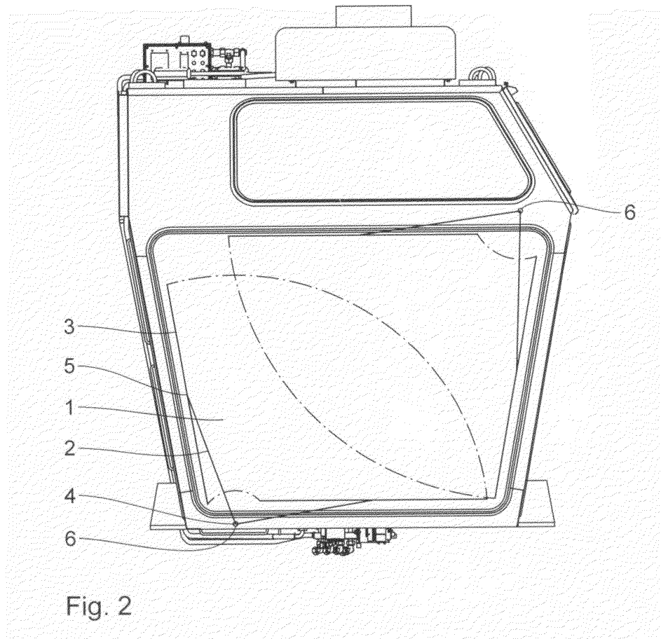

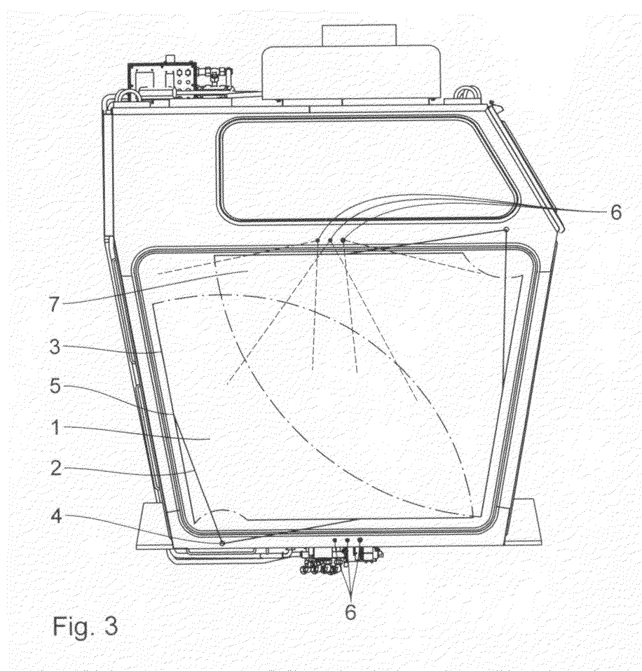

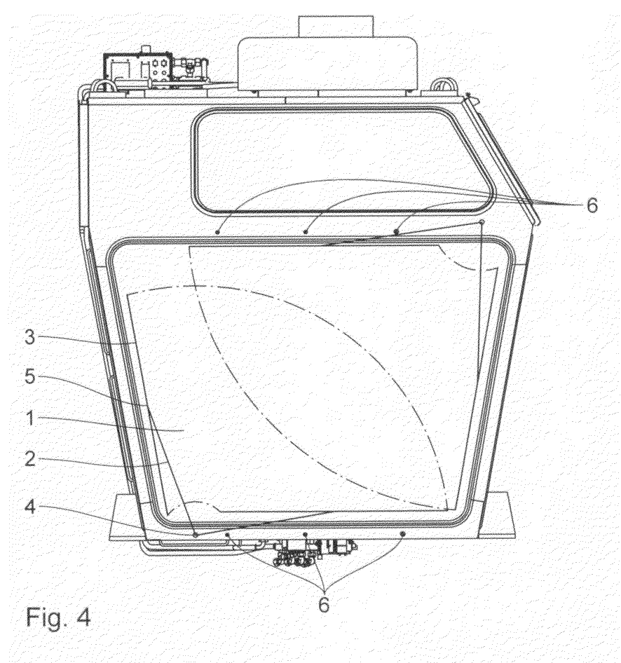

FIG. 2 shows the windshield wiper system of the invention shown in FIG. 1 wherein the spray nozzles 6 are arranged on axes 4 for wiper arms 2. Since the surface to be wiped may be 1 to 4 square meters in size, it has been found advantageous to dispose additional spray nozzles as can be seen for example in FIGS. 3 and 4.

Insofar as the spray nozzles 6 are arranged in a side-by-side relationship as shown in FIG. 3, their spray jet 7 has to be advantageously set at an angle that allows for spraying the entire surface 1 to be wiped.

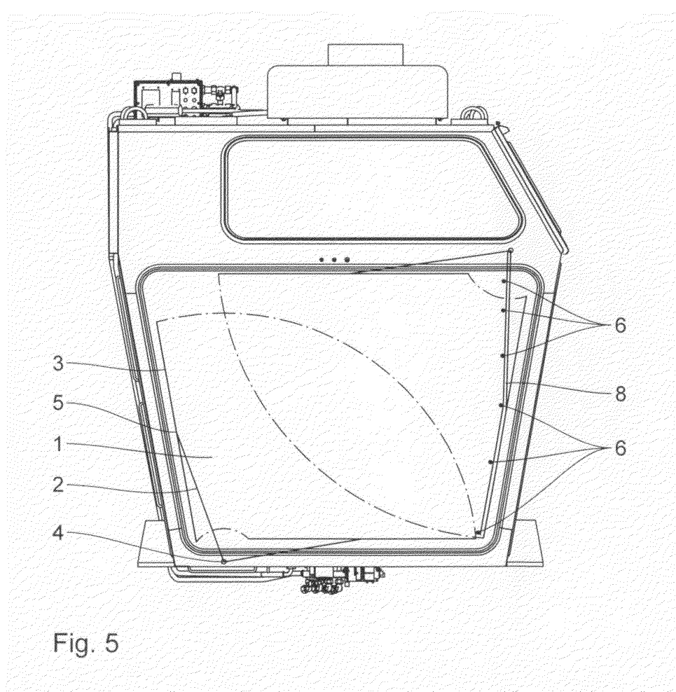

FIG. 5 shows the driver cabin of a straddle carrier with the windshield wiper system of the invention, wherein a hose 8 is led into wiper arm 2 or is fastened thereon, spray nozzles 6 being disposed in hose 8.

Another possibility is to lay hose 8 as far as wiper blade 3 so that spray nozzles 6 can be disposed both on wiper blade 3 and on wiper arm 2.

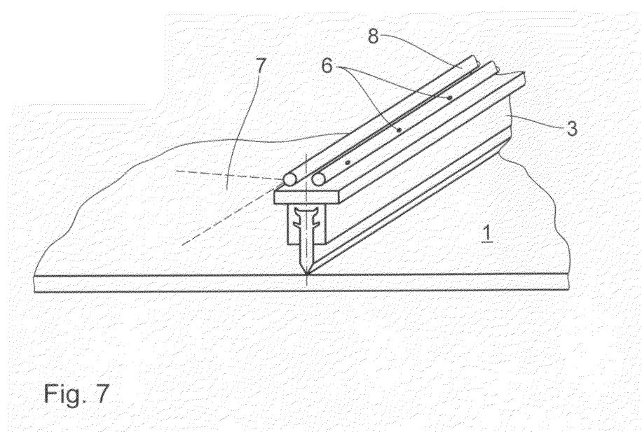

FIG. 7 shows how two hoses 8 with spray nozzles 6 are arranged on wiper blade 3.

The advantage of the present invention is that the window panes of driver cabins with largely rectangular surface areas can be kept free of dirt at any time under difficult weather conditions over their entire viewing surface so that the operating personnel can view all of the activities taking place about the cabin without having to adopt unfavorable positions with respect to their operating equipment.

Accordingly, while only a few embodiments of the present invention have been shown and described, it is obvious that many changes and modifications may be made thereunto without departing from the spirit and scope of the invention.

What is claimed is:

1. A windshield wiper system for a vehicle cabin, in particular for a vehicle cabin in a straddle carrier, comprising:
two drive motors; and
glass wipers disposed on the drive motors for cleaning a largely rectangular surface area, said glass wipers each comprising a wiper arm and a wiper blade being disposed on a joint of the wiper arm,
wherein the glass wipers are disposed on two axes of the motors, said axes being disposed diagonally in corner regions of the surface to be wiped, and
wherein the wiper blades are guided from a position substantially parallel from one side of the surface to be wiped to substantially parallel to another side of the surface to be wiped.

2. The windshield wiper system as set forth in claim 1, wherein wiper movements of the wiper blades are performed one after the other.

3. The windshield wiper system as set forth in claim 1, wherein each wiper blade has a substantially straight arm.

4. The windshield wiper system as set forth in claim 1, wherein axes of the drive motors are disposed diagonally opposite to each other on the surface to be wiped, with one of the axes being disposed underneath and one of the axes being disposed above the surface to be wiped.

5. The windshield wiper system as set forth in claim 1, further comprising at least one spray nozzle for a glass wash liquid disposed underneath or above the surface to be wiped.

6. The windshield wiper system as set forth in claim 5, wherein the at least one spray nozzle is disposed approximately on an axis in front of at least one of the wiper arms.

7. The windshield wiper system as set forth in claim 5, wherein there are at least three of said spray nozzles disposed on the surface to be wiped.

8. The windshield wiper system as set forth in claim 4, wherein at least one of said spray nozzles is disposed on or in the wiper blade or on or in the wiper arm.

9. The windshield wiper system as set forth in claim 6, wherein said at least one spray nozzle emits a spray jet that is synchronized with one of the wiper blades so that the spray jet is only delivered to the surface to be wiped when the one wiper blade is in a position parallel to one of the sides of the surface area to be wiped.

10. The windshield wiper system as set forth in claim 8, wherein the glass wiper liquid from the spray nozzle is sprayed over the entire surface to be wiped.
